(19) United States
(12) Patent Application Publication
(10) Pub. No.: US 2022/0317486 A1
(43) Pub. Date: Oct. 6, 2022

(54) DISPLAY PANEL AND MOTHERBOARD

(71) Applicant: TCL China Star Optoelectronics Technology Co., Ltd., Shenzhen, Guangdong (CN)

(72) Inventor: Kecheng XIE, Shenzhen, Guangdong (CN)

(73) Assignee: TCL China Star Optoelectronics Technology Co., Ltd., Shenzhen, Guangdong (CN)

(21) Appl. No.: 17/251,892

(22) PCT Filed: Oct. 29, 2020
(86) PCT No.: PCT/CN2020/124621

§ 371 Date: Dec. 14, 2020

(30) Foreign Application Priority Data
Oct. 23, 2020 (CN) 202011149811.X

(51) Int. Cl. G02F 1/1337; G02F 1/1339; G02F 1/1335

(52) U.S. Cl. CPC G02F 1/1337; G02F 1/1339; G02F 1/133512

(57) ABSTRACT

The present disclosure provides a display panel and a motherboard. The display panel includes a display area and a non-display area surrounding the display area. The display panel includes a first substrate, a first alignment layer, and a first adsorption layer. In the display area, the first alignment layer is disposed on the first substrate. In the non-display area, the first adsorption layer is disposed on the first substrate.

### FIELD OF INVENTION

The present disclosure relates to the field of display technologies, and particularly relates to a display panel and a motherboard.

### BACKGROUND OF INVENTION

At present, thin film transistor liquid crystal display devices generally consist of an upper plate and a lower plate. An array layer, a first electrode layer, and a first alignment layer are manufactured on the lower plate. An RGB color resist layer, a second electrode layer, and a second alignment layer are manufactured on the upper plate. Then, a frame glue is coated, liquid crystals are dripped into the lower plate, and the upper plate and the lower plate are paired through the frame glue to form a liquid crystal display device cell.

However, impurities are easily accumulated in liquid crystal cells during a process of coating the first alignment layer and the second alignment layer on the upper plate and the lower plate. As the first alignment layer and the second alignment layer diffuse outwards, the impurities are brought to edges of the first alignment layer and the second alignment layer by the first alignment layer and the second alignment layer. After the liquid crystal cells are paired, it is easy to cause a phenomenon of uneven displays at the edges of the first alignment layer and second alignment layer, thereby making the displays at edges of the liquid crystal cells uneven, and resulting in a low yield rate of the display panels and a low performance of the display panels.

### Technical Problems

The present disclosure provides a display panel and a motherboard to improve a yield rate of the display panel and a performance of the display panel.

### Technical Solutions

The present disclosure provides a display panel. The display panel includes a display area and a non-display area surrounding the display area, and the display panel includes:

a first substrate;

a first alignment layer disposed in the display area, wherein the first alignment layer is disposed on the first substrate; and

a first adsorption layer disposed in the non-display area, wherein the first adsorption layer is disposed on the first substrate.

In the display panel provided by the present disclosure, the first adsorption layer is disposed on a side of the first substrate close to the first alignment layer.

In the display panel provided by the present disclosure, a material of the first adsorption layer and a material of the first alignment layer are same.

In the display panel provided by the present disclosure, a surface of the first adsorption layer is provided with a rough structure.

In the display panel provided by the present disclosure, the first adsorption layer includes a first adsorption part and a second adsorption part, the first adsorption part is disposed on a side of the first substrate close to the first alignment layer, the second adsorption part is disposed on a side of the first substrate away from the first alignment layer, and a thickness of the first adsorption part is less than a thickness of the second adsorption part.

In the display panel provided by the present disclosure, the display panel further includes a second substrate, a second alignment layer, and a second adsorption layer;

in the display area, the second alignment layer is disposed on a side of the second substrate close to the first alignment layer; and

in the non-display area, the second adsorption layer is disposed on the side of the second substrate close to the first alignment layer.

In the display panel provided by the present disclosure, the display panel further includes a frame adhesive layer; and

in the non-display area, the frame adhesive layer is disposed between the first substrate and the second substrate, the frame adhesive layer is disposed around the first alignment layer and the second alignment layer, and the first adsorption layer and the second adsorption layer are disposed on a side of the frame adhesive layer away from the first alignment layer and the second alignment layer.

In the display panel provided by the present disclosure, the display panel further includes a retaining wall; and

in the non-display area, the retaining wall is disposed on the first substrate, and the retaining wall is disposed between the frame adhesive layer and the first adsorption layer.

In the display panel provided by the present disclosure, the display panel further includes a common electrode layer, the common electrode layer is disposed between the second substrate and the second alignment layer, and the frame adhesive layer is disposed between the first substrate and the common electrode layer.

The present disclosure further provides a motherboard. The motherboard includes:

a plurality of display panels arranged at intervals, each of the display panels including a display area and a non-display area surrounding the display area, each of the display panels including:

a first substrate;

a first alignment layer disposed in the display area, wherein the first alignment layer is disposed on the first substrate; and

a first adsorption layer disposed in the non-display area, wherein the first adsorption layer is disposed on the first substrate; and

a sealant disposed around the plurality of the display panels, wherein a part of the first adsorption layer is disposed between the frame adhesive layer at an outermost part of the motherboard and the sealant.

In the motherboard provided by the present disclosure, the first adsorption layer is disposed on a side of the first substrate close to the first alignment layer.

In the motherboard provided by the present disclosure, a material of the first adsorption layer and a material of the first alignment layer are same.

In the motherboard provided by the present disclosure, a surface of the first adsorption layer is provided with a rough structure.

In the motherboard provided by the present disclosure, the first adsorption layer includes a first adsorption part and a second adsorption part, the first adsorption part is disposed on a side of the first substrate close to the first alignment layer, the second adsorption part is disposed on a side of the first substrate away from the first alignment layer, and a thickness of the first adsorption part is less than a thickness of the second adsorption part.

In the motherboard provided by the present disclosure, each of the display panels further includes a second substrate, a second alignment layer, and a second adsorption layer;

in the display area, the second alignment layer is disposed on a side of the second substrate close to the first alignment layer; and

in the non-display area, the second adsorption layer is disposed on the side of the second substrate close to the first alignment layer.

In the motherboard provided by the present disclosure, each of the display panels further includes the frame adhesive layer; and

in the non-display area, the frame adhesive layer is disposed between the first substrate and the second substrate, the frame adhesive layer is disposed around the first alignment layer and the second alignment layer, and the first adsorption layer and the second adsorption layer are disposed on a side of the frame adhesive layer away from the first alignment layer and the second alignment layer.

In the motherboard provided by the present disclosure, each of the display panels further includes a retaining wall; and

in the non-display area, the retaining wall is disposed on the first substrate, and the retaining wall is disposed between the frame adhesive layer and the first adsorption layer.

In the motherboard provided by the present disclosure, each of the display panels further includes a common electrode layer, the common electrode layer is disposed between the second substrate and the second alignment layer, and the frame adhesive layer is disposed between the first substrate and the common electrode layer.

In the motherboard provided by the present disclosure, each of the display panels further includes a black matrix layer, and the black matrix layer is disposed between the second substrate and the second alignment layer.

In the motherboard provided by the present disclosure, each of the display panels further includes a liquid crystal layer, and the liquid crystal layer is disposed between the first alignment layer and the second alignment layer.

### Beneficial Effects

The present disclosure provides a display panel and a motherboard. In the display panel, by providing a first adsorption layer on a first substrate, impurities on a first alignment layer can be adsorbed to the first adsorption layer, thereby reducing the impurities in a display area, reducing uneven displays at an edge of a liquid crystal cell, and improving a yield rate of the display panel and a performance of the display panel.

### DESCRIPTION OF DRAWINGS

The technical solutions, as well as other beneficial advantages, of the present disclosure will be apparent from the following detailed descriptions of embodiments of the present disclosure, with reference to the attached drawings.

FIG. 1 is a first structural sectional diagram of a display panel provided by an embodiment of the present disclosure.

FIG. 2 is a second structural sectional diagram of the display panel provided by an embodiment of the present disclosure.

FIG. 3 is a third structural sectional diagram of the display panel provided by an embodiment of the present disclosure.

FIG. 4 is a fourth structural sectional diagram of the display panel provided by an embodiment of the present disclosure.

FIG. 5 is a fifth structural sectional diagram of the display panel provided by an embodiment of the present disclosure.

FIG. 6 is a sixth structural sectional diagram of the display panel provided by an embodiment of the present disclosure.

FIG. 7 is a seventh structural sectional diagram of the display panel provided by an embodiment of the present disclosure.

FIG. 8 is a plan diagram of a motherboard provided by an embodiment of the present disclosure.

### DETAILED DESCRIPTION OF EMBODIMENTS

The technical solutions in the embodiments of the present disclosure will be described clearly and completely hereafter with reference to the accompanying drawings. Apparently, the described embodiments are only a part of but not all embodiments of the present disclosure. All other embodiments obtained by persons of ordinary skill in the art based on the embodiments of the present disclosure without creative efforts shall fall within the protection scope of the present disclosure.

Referring to FIG. 1, FIG. 1 is a first structural sectional diagram of a display panel provided by an embodiment of the present disclosure. The present disclosure provides a display panel 10. The display panel 10 includes a display area 11 and a non-display area 12 surrounding the display area 11. The display panel 10 includes a first substrate 100, a first alignment layer 200, and a first adsorption layer 300. Specific descriptions are as following:

The first substrate 100 may be a rigid substrate or a flexible substrate. A material of the first substrate 100 may include polyimide or glass, etc., but is not limited thereto.

In an embodiment, the display panel 10 further includes a transistor layer 400. The transistor layer 400 is disposed on the first substrate 100.

In the display area 11, the first alignment layer 200 is disposed on the first substrate 100. A material of the first alignment layer 200 may be polyimide.

In the non-display area 12, the first adsorption layer 300 is disposed on the first substrate 100. A material of the first adsorption layer 300 may be polyimide. The first alignment layer 200 and the first adsorption layer 300 may be made in a same process.

In the present disclosure, the first adsorption layer 300 is disposed on the first substrate 100, and the first adsorption layer 300 is disposed on the non-display area 12. When a solution of the first alignment layer 200 is coated on the first substrate 100, the solution of the first alignment layer 200 may diffuse along a direction from the display area 11 to the first adsorption layer 300. As impurities in the display panel 10 flow with the solution of the first alignment layer 200, the impurities gradually approach the first adsorption layer 300, the impurities on the first alignment layer 200 or the impurities present at an edge of the first alignment layer 200 are adsorbed to the first adsorption layer 300, thereby reducing influences of the impurities on the first alignment layer 200, and relieving a phenomenon of uneven displays of a panel 10 in the display area. That is, a yield rate of the display panel 10 and a performance of the display panel 10 are improved.

In an embodiment, the first adsorption layer 300 is disposed on a side of the first substrate close to the first alignment layer 200, thereby relieving the phenomenon of the uneven displays of the display panel 10. That is, the yield rate of the display panel 10 and the performance of the display panel 10 are improved.

Alternatively, the display panel 10 at least includes two first adsorption layers 300.

In an embodiment, the display panel 10 further includes a second substrate 500, a second alignment layer 600, and a second adsorption layer 700. In the display area 11, the second alignment layer 600 is disposed on a side of the second substrate 500 close to the first alignment layer 200. The second substrate 500 may be a rigid substrate or a flexible substrate. A material of the second substrate 500 may include polyimide or glass, etc., but is not limited thereto. In the non-display area 12, the second adsorption layer 700 is disposed on the side of the second substrate 500 close to the first alignment layer 200. A material of the second adsorption layer 700 includes polyimide.

In the present disclosure, in the non-display area 12, the first adsorption layer 300 and the second adsorption layer 700 are disposed on the first substrate 100 and the second substrate 500, respectively, thereby further reducing the impurities on or at the edges of the first alignment layer 200 and the second alignment layer 600, further relieving the phenomenon of the uneven displays of the display panel 10, and further improving the yield rate of the display panel 10 and the performance of the display panel.

In an embodiment, the display panel 10 further includes a black matrix layer 800. The black matrix layer 800 is disposed on the second substrate 500.

In an embodiment, the display panel 10 further includes a common electrode layer 900. The common electrode layer 900 is disposed between the second substrate 500 and the second alignment layer 600. A material of the common electrode layer 900 may include indium tin oxide, but is not limited thereto.

In an embodiment, the display panel 10 further includes a liquid crystal layer 1000. The liquid crystal layer 1000 is disposed between the first alignment layer 200 and the second alignment layer 600.

In an embodiment, the display panel 10 further includes a frame adhesive layer 1100. In the non-display area 12, the frame adhesive layer 1100 is disposed between the first substrate 100 and the second substrate 500. The frame adhesive layer 1100 is disposed around the first alignment layer 200 and the second alignment layer 600. The first adsorption layer 300 and the second adsorption layer 700 are disposed on a side of the frame adhesive layer 1100 away from the first alignment layer 200 and the second alignment layer 600. Specifically, in the non-display area 12, the frame adhesive layer 1100 is disposed between the first substrate 100 and the common electrode layer 900.

In the present disclosure, the frame adhesive layer 1100 is disposed between the first alignment layer 200 and the first adsorption layer 300, the first adsorption layer 300 is separated from the first alignment layer 200, so the impurities adsorbed by the first adsorption layer 300 are isolated to prevent the influences of the impurities adsorbed by the first adsorption layer 300 on the display area 11, thereby relieving the phenomenon of the uneven displays at the edge of the liquid crystal layer, and further improving the yield rate of the display panel 10 and the performance of the display panel.

In an embodiment, the display panel 10 further includes a retaining wall 1200. In the non-display area 12, the retaining wall 1200 is disposed on the first substrate 100. The retaining wall 1200 is disposed between the frame adhesive layer 1100 and the first adsorption layer 300.

In the present disclosure, the retaining wall 1200 is disposed between the frame adhesive layer 1100 and the first adsorption layer 300 to prevent the impurities on the first adsorption layer 300 from contacting the frame adhesive layer 1100, thereby preventing the influences of the impurities on the frame adhesive layer 1100, preventing a leakage of the liquid crystal layer 1000, improving display effects of the display panel 10, and improving the yield rate of the display panel 10 and the performance of the display panel.

In an embodiment, the display panel 10 further includes a blocking structure 1300. The blocking structure 1300 is disposed on the first substrate 100 between the first alignment layer 200 and the frame adhesive layer 1100. The blocking structure 1300 is in contact with an end of the first alignment layer 200. The blocking structure 1300 is configured to block the first alignment layer 200 from diffusing outwards.

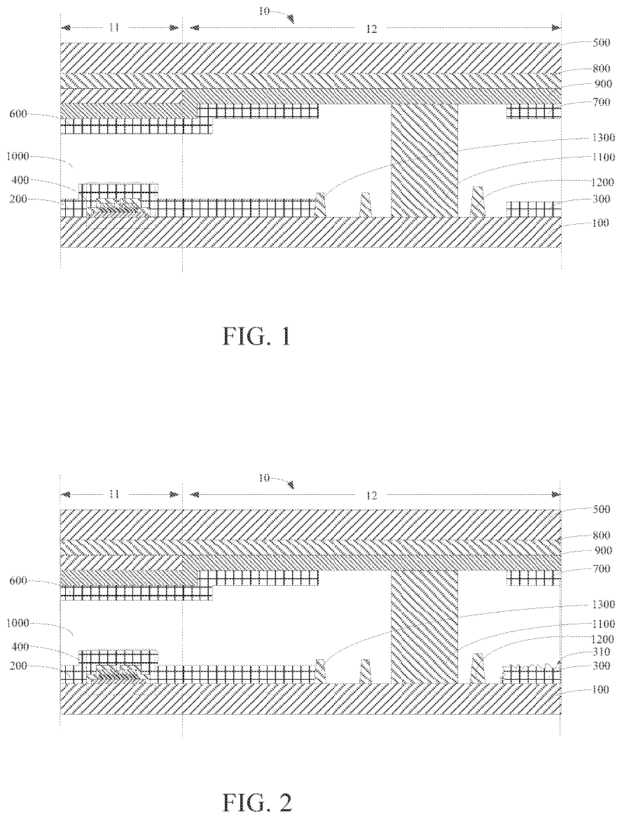

Referring to FIG. 2, FIG. 2 is a second structural sectional diagram of the display panel provided by an embodiment of the present disclosure. It should be noted that, differences between the second structure and the first structure in the embodiment are:

A surface of the first adsorption layer 300 is provided with a rough structure 310.

In the present disclosure, the rough structure 310 is disposed on the surface of the first adsorption layer 300, so the first adsorption layer 300 can adsorb more impurities, thereby relieving the phenomenon of the uneven displays at the edge of the liquid crystal cell, improving the display effects of the display panel 10, and improving the yield rate of the display panel 10 and the performance of the display panel.

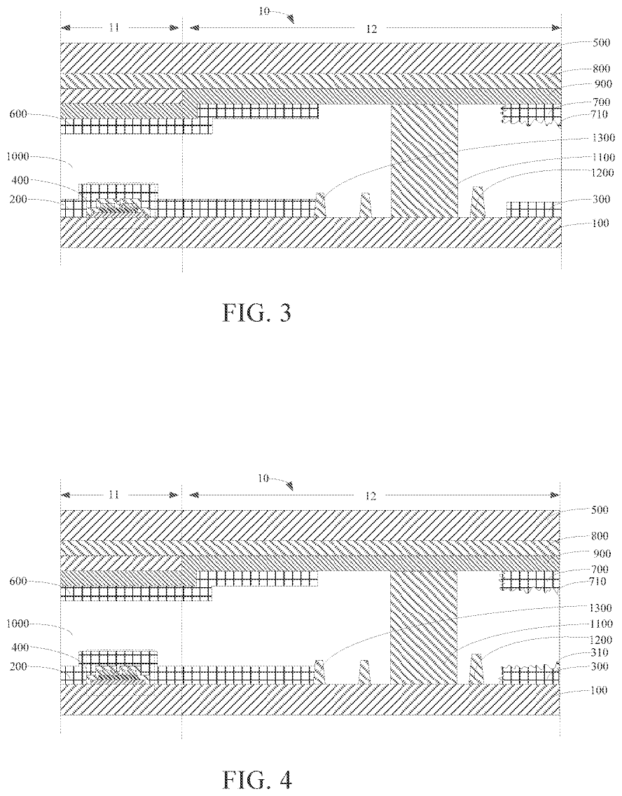

Referring to FIG. 3, FIG. 3 is a third structural sectional diagram of the display panel provided by an embodiment of the present disclosure. It should be noted that, differences between the third structure and the first structure in the embodiment are:

A surface of the second adsorption layer 700 is provided with a rough structure 710.

In the present disclosure, the rough structure 710 is disposed on the surface of the second adsorption layer 700, so that the second adsorption layer 700 can adsorb more impurities, thereby relieving the phenomenon of the uneven displays at the edge of the liquid crystal cell, improving the display effects of the display panel 10, and improving the yield rate of the display panel 10 and the performance of the display panel.

Referring to FIG. 4, FIG. 4 is a fourth structural sectional diagram of the display panel provided by an embodiment of the present disclosure. It should be noted, that differences between the fourth structure and the first structure in the embodiment are:

The surface of the first adsorption layer 300 is provided with the rough structure 310. The surface of the second adsorption layer 700 is provided with the rough structure 710.

In the present disclosure, the rough structure 310 and the rough structure 710 are disposed on the surfaces of the first adsorption layer 300 and the second adsorption layer 700, respectively, to increase surface areas of the first adsorption layer 300 and the second adsorption layer 700, so the first adsorption layer 300 and the second adsorption layer 700 can adsorb more impurities, thereby relieving the phenomenon of the uneven displays at the edge of the liquid crystal cell, improving the display effects of the display panel 10, and improving the yield rate of the display panel 10 and the performance of the display panel.

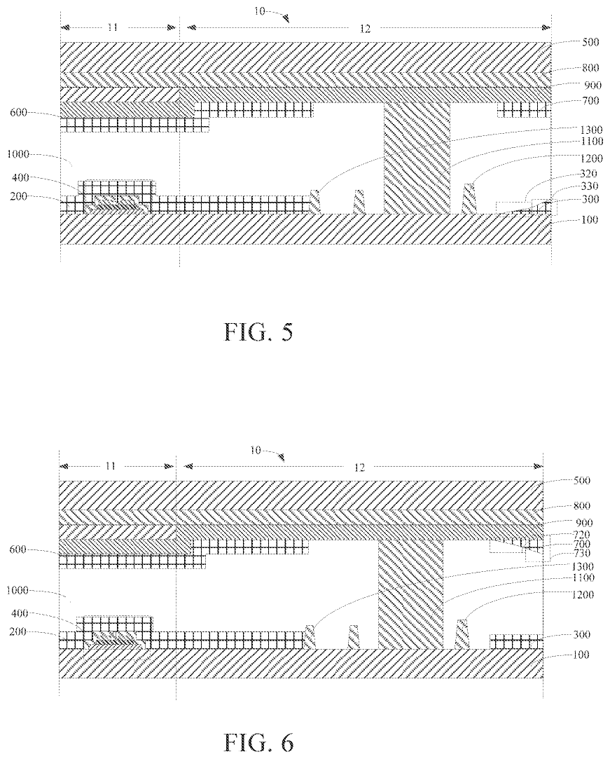

Referring to FIG. 5, FIG. 5 is a fifth structural sectional diagram of the display panel provided by an embodiment of the present disclosure. It should be noted that, differences between the fifth structure and the first structure in the embodiment are:

The first adsorption layer 300 includes a first adsorption part 320 and a second adsorption part 330. The first adsorption part 320 is disposed on the side of close to the first alignment layer 200. The second adsorption part 330 is disposed on a side of away from the first alignment layer 200. A thickness of the first adsorption part 320 is less than a thickness of the second adsorption part 330. Specifically, a thickness of the first adsorption layer 300 gradually increases from an end close to the retaining wall 1200 to an end away from the retaining wall 1200.

In the present disclosure, in a direction from the end close to the retaining wall 1200 to the end away from the retaining wall 1200, the thickness of the first adsorption layer 300 are designed to be gradually increased, which increases the surface area of the first adsorption layer 300 to make the first adsorption layer 300 adsorb more impurities, thereby relieving the phenomenon of the uneven displays at the edge of the liquid crystal cell, improving the display effects of the display panel 10, and improving the yield rate of the display panel 10 and the performance of the display panel.

Referring to FIG. 6, FIG. 6 is a sixth structural sectional diagram of the display panel provided by an embodiment of the present disclosure. It should be noted that, differences between the sixth structure and the first structure in the embodiment are:

The second adsorption layer 700 includes a third adsorption part 720 and a fourth adsorption part 730. The third adsorption part 720 is disposed on a side of close to the second alignment layer 600. The fourth adsorption part 730 is disposed on a side of away from the second alignment layer 600. A thickness of the third adsorption part 720 is less than a thickness of the fourth adsorption part 730. Specifically, a thickness of the second adsorption layer 700 gradually increases from an end close to the frame adhesive layer 1100 to an end away from the frame adhesive layer 1100.

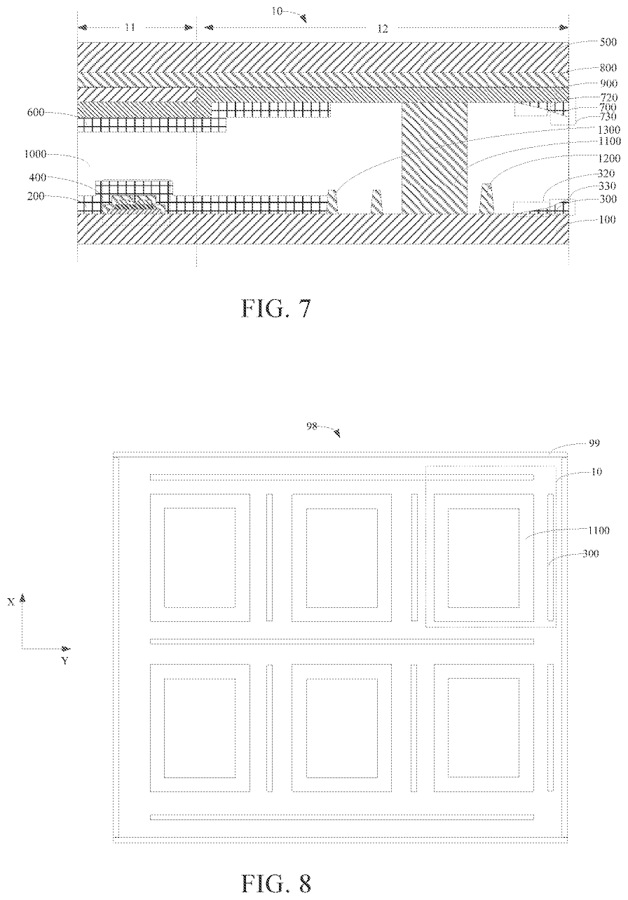

Referring to FIG. 7, FIG. 7 is a first structural sectional diagram of the display panel provided by an embodiment of the present disclosure. It should be noted that, differences between the seventh structure and the fifth structure in the embodiment are:

The first adsorption layer 300 includes the first adsorption part 320 and the second adsorption part 330. The second adsorption layer 700 includes the third adsorption part 720 and the fourth adsorption part 730.

In the present disclosure, in a direction from the end close to the retaining wall 1200 to the end away from the retaining wall 1200, the thickness of the first adsorption layer 300 is designed to be gradually increased, and in a direction from the end close to the frame adhesive layer 1100 to the end away from the frame adhesive layer 1100, the thickness of the second adsorption layer 700 is designed to be gradually increased, which increases the surface areas of the first adsorption layer 300 and the second adsorption layer 700 to make the first adsorption layer 300 and the second adsorption layer 700 adsorb more impurities, thereby relieving the phenomenon of the uneven displays at the edge of the liquid crystal cell, improving the display effects of the display panel 10, and improving the yield rate of the display panel 10 and the performance of the display panel.

The present disclosure provides the display panel, the first adsorption layer and the second adsorption layer are disposed on the first substrate and the second substrate, respectively, to make the first adsorption layer and the second adsorption layer adsorb the impurities on or at the edges of first adsorption layer and the second adsorption layer, thereby relieving the phenomenon of the uneven displays at the edge of the liquid crystal cell, and improving the yield rate of the display panel 10 and the performance of the display panel.

Referring to FIG. 8, FIG. 8 is a plan diagram of a motherboard provided by an embodiment of the present disclosure. The present disclosure further provides a motherboard 98. The motherboard 98 includes the display panel 10 as described above and a sealant 99. Specific descriptions are as following:

The motherboard 98 a plurality of the display panels 10. The display panels 10 are arranged at intervals.

The sealant 99 is disposed around the plurality of the display panels 10. A part of the first adsorption layer 300 is disposed between an outermost part of the frame adhesive layers 1100 and the sealant 99 of the motherboard 98.

Specifically, the motherboard 98 is provided with a first direction Y and a second direction X. The first direction Y is perpendicular to the second direction X. The first direction Y refers to an extending direction of the first alignment layer 300.

Two adjacent first alignment layers 300 in each of rows extending along the first direction Y are connected end to end to form a continuous strip structure. Two adjacent first alignment layers 300 in each of columns extending along the second direction X are arranged at intervals, and strip structures are arranged.

The present disclosure provides the display panel and the motherboard. In the display panel, by providing the first adsorption layer on the first substrate, the impurities on the first alignment layer may be adsorbed to the first adsorption layer, thereby reducing the impurities in the display area, relieving the phenomenon of the uneven displays at the edge of the liquid crystal cell, and improving the yield rate of the display panel and the performance of the display panel.

The embodiments of the present disclosure are described in detail above. The principle and implementations of the present disclosure are described in this specification by using specific examples. The description about the foregoing embodiments is merely provided to help understand the method and core ideas of the present disclosure. Persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1. A display panel, comprising a display area and a non-display area surrounding the display area, the display panel comprising:
a first substrate;
a first alignment layer disposed in the display area, wherein the first alignment layer is disposed on the first substrate; and
a first adsorption layer disposed in the non-display area, wherein the first adsorption layer is disposed on the first substrate.

2. The display panel in claim 1, wherein the first adsorption layer is disposed on a side of the first substrate close to the first alignment layer.

3. The display panel in claim 1, wherein a material of the first adsorption layer and a material of the first alignment layer are same.

4. The display panel in claim 1, wherein a surface of the first adsorption layer is provided with a rough structure.

5. The display panel in claim 1, wherein the first adsorption layer comprises a first adsorption part and a second adsorption part, the first adsorption part is disposed on a side of the first substrate close to the first alignment layer, the second adsorption part is disposed on a side of the first substrate away from the first alignment layer, and a thickness of the first adsorption part is less than a thickness of the second adsorption part.

6. The display panel in claim 1, wherein the display panel further comprises a second substrate, a second alignment layer, and a second adsorption layer;
in the display area, the second alignment layer is disposed on a side of the second substrate close to the first alignment layer; and
in the non-display area, the second adsorption layer is disposed on the side of the second substrate close to the first alignment layer.

7. The display panel in claim 6, wherein the display panel further comprises a frame adhesive layer; and
in the non-display area, the frame adhesive layer is disposed between the first substrate and the second substrate, the frame adhesive layer is disposed around the first alignment layer and the second alignment layer, and the first adsorption layer and the second adsorption layer are disposed on a side of the frame adhesive layer away from the first alignment layer and the second alignment layer.

8. The display panel in claim 7, wherein the display panel further comprises a retaining wall; and
in the non-display area, the retaining wall is disposed on the first substrate, and the retaining wall is disposed between the frame adhesive layer and the first adsorption layer.

9. The display panel in claim 7, wherein the display panel further comprises a common electrode layer, the common electrode layer is disposed between the second substrate and the second alignment layer, and the frame adhesive layer is disposed between the first substrate and the common electrode layer.

10. A motherboard, comprising:
a plurality of display panels arranged at intervals, each of the display panels comprising a display area and a non-display area surrounding the display area, each of the display panels comprising:
a first substrate;
a first alignment layer disposed in the display area, wherein the first alignment layer is disposed on the first substrate; and
a first adsorption layer disposed in the non-display area, wherein the first adsorption layer is disposed on the first substrate;
a frame adhesive layer; and
a sealant disposed around the plurality of the display panels, wherein a part of the first adsorption layer is disposed between the frame adhesive layer at an outermost part of the motherboard and the sealant.

11. The motherboard in claim 10, wherein the first adsorption layer is disposed on a side of the first substrate close to the first alignment layer.

12. The motherboard in claim 10, wherein a material of the first adsorption layer and a material of the first alignment layer are same.

13. The motherboard in claim 10, wherein a surface of the first adsorption layer is provided with a rough structure.

14. The motherboard in claim 10, wherein the first adsorption layer comprises a first adsorption part and a second adsorption part, the first adsorption part is disposed on a side of the first substrate close to the first alignment layer, the second adsorption part is disposed on a side of the first substrate away from the first alignment layer, and a thickness of the first adsorption part is less than a thickness of the second adsorption part.

15. The motherboard in claim 10, wherein each of the display panels further comprises a second substrate, a second alignment layer, and a second adsorption layer;
in the display area, the second alignment layer is disposed on a side of the second substrate close to the first alignment layer; and
in the non-display area, the second adsorption layer is disposed on the side of the second substrate close to the first alignment layer.

16. The motherboard in claim 15, wherein
in the non-display area, the frame adhesive layer is disposed between the first substrate and the second substrate, the frame adhesive layer is disposed around the first alignment layer and the second alignment layer, and the first adsorption layer and the second adsorption layer are disposed on a side of the frame adhesive layer away from the first alignment layer and the second alignment layer.

17. The motherboard in claim 16, wherein each of the display panels further comprises a retaining wall; and
in the non-display area, the retaining wall is disposed on the first substrate, and the retaining wall is disposed between the frame adhesive layer and the first adsorption layer.

18. The motherboard in claim 15, wherein each of the display panels further comprises a common electrode layer, the common electrode layer is disposed between the second substrate and the second alignment layer, and the frame adhesive layer is disposed between the first substrate and the common electrode layer.

19. The motherboard in claim 15, wherein each of the display panels further comprises a black matrix layer, and the black matrix layer is disposed between the second substrate and the second alignment layer.

20. The motherboard in claim 15, wherein each of the display panels further comprises a liquid crystal layer, and the liquid crystal layer is disposed between the first alignment layer and the second alignment layer.
